(19) United States
(12) Patent Application Publication
(10) Pub. No.: US 2026/0050095 A1
(43) Pub. Date: Feb. 19, 2026

(54) INSULATION SYSTEM FOR THERMOELECTRIC COOLERS IN ENERGY DISPERSIVE X-RAY DETECTORS USING AEROGEL TECHNOLOGY

(71) Applicant: Creighton Scientific, Inc., Highland, UT (US)

(72) Inventor: Richard Thomas Creighton, Highland, UT (US)

(73) Assignee: Creighton Scientific, Inc., Highland, UT (US)

(21) Appl. No.: 19/300,566

(22) Filed: Aug. 14, 2025

Related U.S. Application Data
(60) Provisional application No. 63/683,472, filed on Aug. 15, 2024.

(51) Int. Cl. G01T 7/00; F16L 59/02; F25B 21/02

(52) U.S. Cl. CPC G01T 7/00; F16L 59/028; F25B 21/02

(57) ABSTRACT

An X-ray detector may include an aerogel insulator that encapsulates one or more of a thermoelectric cooler (TEC) and sensor of the X-ray detector to provide insulation in place of vacuum encapsulation. The aerogel insulator can be poured in gel form into an assembled X-ray detector to encapsulate components of the X-ray detector such as the TEC, wire bonds, amplifier, and potentially the sensor, and then dried to form the aerogel insulator.

### CROSS-REFERENCE TO RELATED APPLICATIONS

This application claims priority to U.S. Provisional Application No. 63/683,472, filed Aug. 15, 2024, which application is incorporated herein by reference.

### BACKGROUND

Conventional energy dispersive X-ray detectors employ thermoelectric coolers (TECs) to maintain the detectors at low temperatures, which is essential for minimizing thermal noise and maximizing detection resolution. Typically, these detectors use vacuum encapsulation and thin beryllium windows to insulate the TECs from external thermal influences and to allow X-rays reach the sensor. However, vacuum encapsulation is complex and costly, and beryllium windows present challenges related to material handling and cost.

### BRIEF DESCRIPTION OF THE DRAWINGS

The accompanying drawings are not intended to be drawn to scale. For purposes of clarity, not every component may be labeled in every drawing.

FIG. 1 illustrates a conventional X-ray detector utilizing vacuum encapsulation.

FIG. 2 illustrates an X-ray detector including an aerogel insulator, according to one embodiment of the present disclosure.

FIG. 3 illustrates an endcap including an aerogel window, according to one embodiment of the present disclosure.

FIG. 4 illustrates an X-ray detector including an aerogel insulator to insulate a thermoelectric cooler (TEC) of the X-ray detector, according to one embodiment of the present disclosure.

FIG. 5 illustrates an X-ray detector including an aerogel insulator to insulate a thermoelectric cooler (TEC) of the X-ray detector, according to one embodiment of the present disclosure.

FIG. 6 illustrates the X-ray detector coupled to an endcap, according to one embodiment of the present disclosure.

FIG. 7 is a chart comparing X-ray transmission of an example aerogel sample and beryllium.

FIG. 8 is a chart comparing X-ray transmission of another example aerogel sample and beryllium.

FIG. 9 is a chart comparing X-ray transmission of another example aerogel sample and beryllium.

FIG. 10 is a flow diagram illustrating operations of a method for manufacturing an X-ray detector including an aerogel insulator, according to one embodiment of the present disclosure.

FIG. 11 illustrates a flow diagram illustrating operations of a method for manufacturing an X-ray detector that includes an aerogel insulator, using a mold, according to one embodiment of the present disclosure.

FIG. 12 illustrates a flow diagram illustrating operations of a method for manufacturing an X-ray detector including an aerogel insulator and an insulating window, according to one embodiment of the present disclosure.

FIG. 13 is a flow diagram illustrating operations of a method for manufacturing an X-ray detector including an aerogel insulator formed within a mold and an insulating window, according to one embodiment of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

The present disclosure provides an innovative solution for enhancing the reliability of energy dispersive X-ray detectors (EDXRDs) and reducing their manufacturing cost by utilizing aerogels as an insulating material in the detector's thermoelectric coolers. This technology eliminates the need for traditional vacuum encapsulation and the use of thin beryllium windows, offering a safer, more reliable, and cost-effective alternative.

Aerogels are highly effective thermal insulators with low thermal conductivity and very low densities. The present disclosure provides for replacing both vacuum encapsulation and thin beryllium windows with an aerogel-based insulation system for dispersive X-ray detectors. The application of aerogels in this context provides substantial improvements in reducing manufacturing cost and complexity. In addition, the aerogel insulation allows for modification of the form factor of the detector while maintaining comparable cooling efficiencies to vacuum encapsulated designs.

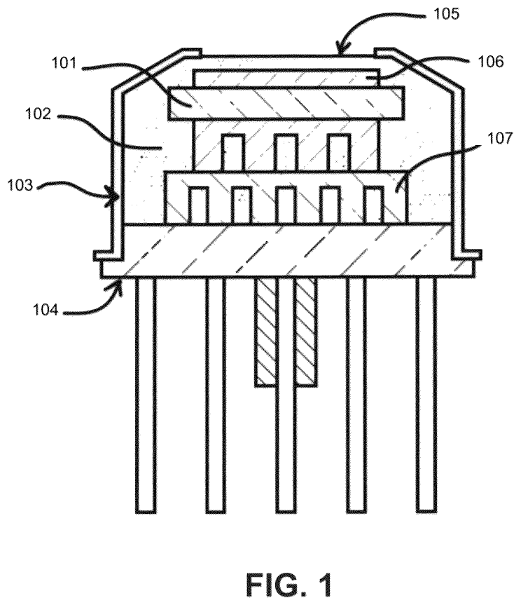

FIG. 1 illustrates a conventional X-ray detector utilizing vacuum encapsulation. The X-ray detector includes an electronic substrate 101, an endcap 103, a header 104, an X-ray window 105, a detector sensor 106, and a thermoelectric cooler (TEC) 107. The endcap 103 is sometimes referred to as a housing of the X-ray detector. The volume 102 bounded by the metal endcap 103, the X-ray window 105, and the header 104 is under vacuum in order to insulate the sensor 106 and the TEC 107. This vacuum insulation isolates the TEC 107 and the sensor 106 from external thermal influences, such as ambient air, in order to minimize thermal noise and maximize detection resolution using the sensor 106. In this way, the TEC 107 and the sensor 106 are vacuum encapsulated to provide insulation. The header 104 includes a vacuum feedthrough to provide the vacuum for insulation. The TEC 107 cools the sensor 106 to maintain a target temperature to reduce thermal noise (e.g., Johnson noise). The insulation provided by the vacuum encapsulation allows the TEC 107 to maintain the target temperature, or allows the TEC 107 to maintain the target temperature with greater efficiency than without the insulation. However, the volume 102 can, over time, degrade or be damaged and lose vacuum, reducing the insulation provided to the TEC 107 and sensor 106 and increasing thermal noise.

The X-ray window 105 is a beryllium window to allow for X-ray transmission while maintaining structural integrity to maintain the vacuum encapsulation. In some implementations, the X-ray window 105 is a beryllium window having a thickness of 8 microns, a conventional thickness for beryllium windows. The endcap 103 may be metal, providing structural integrity, but not X-ray transmission.

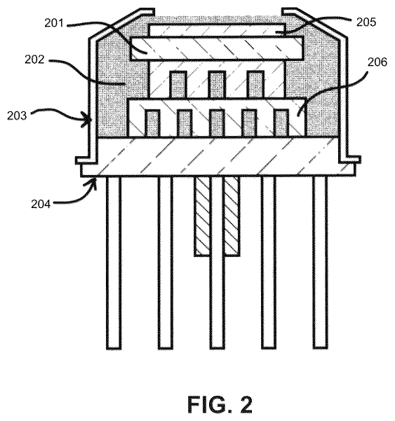

FIG. 2 illustrates an X-ray detector including an aerogel insulator 202. The X-ray detector includes an electronic substrate 201, an aerogel insulator 202, a metal endcap 203, a header 204, a detector sensor 205, and a thermoelectric cooler (TEC) 206. The X-ray detector of FIG. 2 may be similar to the X-ray detector of FIG. 1, with the exception that instead of vacuum encapsulation, insulation of the sensor 205 and the TEC 206 is provided by the aerogel insulator 202. As the interior of the X-ray detector of FIG. 2 is not under vacuum, an X-ray window is not required. Without the need to maintain vacuum, the X-ray detector of FIG. 2 is greatly simplified, increasing a longevity and reliability of the X-ray detector. The aerogel insulator 202 may be configured to be deposited, located, or otherwise disposed within the endcap 203 of an X-ray detector. The aerogel insulator 202 may provide approximately equivalent thermal insulation as vacuum encapsulation.

The electronic substrate 201, the metal endcap 203, the header 204, the detector sensor 205, and the thermoelectric cooler (TEC) 206 may all be the same as the relevant components described in FIG. 1. The aerogel insulator 202 may be provided within the X-ray detector by pouring or dispensing a precursor gel or solution into the X-ray detector to cover the interior components of the X-ray detector and drying the precursor gel to form the aerogel insulator 202 encapsulating the TEC 206, electronic substrate 201, and sensor 205. In some implementations, the aerogel insulator 202 is inserted in the X-ray detector as a flexible sheet or blanket to surround the TEC 206, the electronic substrate 201, and sensor 205.

In some implementations, the aerogel insulator 202 is a composite material including additional X-ray transparent materials. In an example, a thin film is deposited or placed over the aerogel insulator 202 to prevent moisture from being absorbed by the aerogel insulator 202. In an example, an adhesive is disposed within the endcap 203 to adhere the aerogel insulator 202 to the endcap 203. In some implementations, the aerogel insulator 202 is secured in place within the endcap 203 due to a geometry of the endcap 203 or due to the aerogel insulator 202 being formed within the endcap 203.

The aerogel insulator 202 may be a silica-based aerogel, carbon-based aerogel, metal oxide-based aerogel, and/or polymer-based aerogel. For example, a silica-based aerogel may be formed using tetraethyl orthosilicate (TEOS) as a precursor with an acid catalyst, resulting in a highly porous structure with excellent thermal insulation properties. In another example, a resorcinol-formaldehyde aerogel may be used, which can be carbonized to form a carbon-based aerogel with enhanced structural stability while maintaining low thermal conductivity.

The formation of aerogels may involve a multi-step process that begins with the creation of a wet gel through sol-gel chemistry, where precursor materials undergo hydrolysis and condensation reactions to form a three-dimensional network structure. Following gel formation, the liquid within the gel pores may be removed through supercritical drying, a process that involves replacing the pore liquid with a supercritical fluid such as supercritical carbon dioxide. During supercritical drying, the fluid is maintained above its critical temperature and pressure, allowing it to be removed without creating a liquid-vapor interface that would otherwise cause the delicate gel structure to collapse due to capillary forces. This supercritical drying process preserves the nanoporous structure of the gel, resulting in an aerogel with extremely low density and exceptional thermal insulation properties.

The aerogel insulator 202 may have a thermal conductivity between 0.0 W/m·K and 0.03 W/m·K. For instance, a silica aerogel with a density of 0.003 g/cm³ may exhibit a thermal conductivity of approximately 0.015 W/m·K, while an aluminum oxide-based aerogel may achieve thermal conductivity values as low as 0.012 W/m·K at similar densities. The low thermal conductivity of the aerogel insulator 202 reduces thermal bridging between the TEC 206 and an environment of the X-ray detector, allowing the TEC 206 to maintain the sensor 205 at a target temperature with high efficiency.

The aerogel insulator 202 can withstand operational temperature of the X-ray detector without degradation. In an example, the aerogel insulator 202 can withstand temperatures between ten and one hundred degrees Celsius. For instance, a silica-based aerogel formulation with a density of 0.0025 g/cm³ has been demonstrated to maintain structural integrity and thermal insulation properties when subjected to temperature cycling between −20° C. and 80° C. for over 1000 cycles, simulating years of operational use in varying environmental conditions. In another example, a carbon-based aerogel with a density of 0.006 g/cm³ exhibited less than 2% change in thermal conductivity after continuous exposure to 90° C. for 30 days, demonstrating excellent thermal stability for long-term detector operation. The aerogel insulator 202 may have a density between 0.00011 g/cm3 and 0.02 g/cm3. For example, an ultra-low density silica aerogel with 0.0002 g/cm³ provides exceptional thermal insulation with a thermal conductivity of approximately 0.012 W/m·K while maintaining sufficient structural integrity for detector applications. Conversely, a higher density aerogel at 0.015 g/cm³ offers enhanced mechanical strength with only a modest increase in thermal conductivity to approximately 0.018 W/m·K, providing a balance between durability and insulation performance for applications requiring greater structural robustness.

A thickness of the aerogel insulator 202 above the sensor 205, a thickness of a layer of the aerogel insulator 202 on the sensor, or a distance the aerogel insulator 202 extends above the sensor 205, may be between 0.2 mm and 1 mm. In some implementations, the thickness of the aerogel insulator 202 above the sensor 205 is greater than 1 mm. The thickness and density of the aerogel insulator 202 above the sensor 205 may be selected for a specific implementation as a balance between thermal insulation and X-ray transparency.

In some implementations, the aerogel insulator 202 may include light blocking capabilities to prevent visible light from interfering with the detector sensor 205. The aerogel insulator 202 may not be completely opaque to visible light in certain formulations, which could potentially affect sensor performance by introducing unwanted optical noise. To address this, a light blocking material may be incorporated into or deposited onto the aerogel insulator 202. For example, a thin layer of carbon nanotubes may be deposited on the surface of the aerogel insulator 202 to provide effective visible light blocking while maintaining X-ray transparency. The carbon nanotube layer may be deposited using various techniques such as spray coating, dip coating, or chemical vapor deposition to create a uniform light-blocking barrier. In some cases, the carbon nanotube layer may have a thickness between 10 nanometers and 1 micrometer to achieve adequate light blocking without significantly impeding X-ray transmission.

Alternatively, the aerogel insulator 202 may be formulated with chemical compositions that inherently provide visible light opacity while preserving X-ray transmission. The aerogel precursor solution may be modified to include functional groups or additives that selectively absorb visible light wavelengths. For instance, organic chromophores or metal oxide nanoparticles may be incorporated into the aerogel matrix during the gelation process to create light-absorbing centers within the aerogel structure. These functional groups may be selected to have strong absorption in the visible spectrum while having minimal interaction with X-ray photons due to their higher energy. In some implementations, the aerogel may be doped with materials such as iron oxide nanoparticles or organic dyes that provide the desired optical properties. The concentration of these light-blocking additives may be optimized to achieve effective visible light attenuation while maintaining the low density and thermal insulation properties of the aerogel insulator 202.

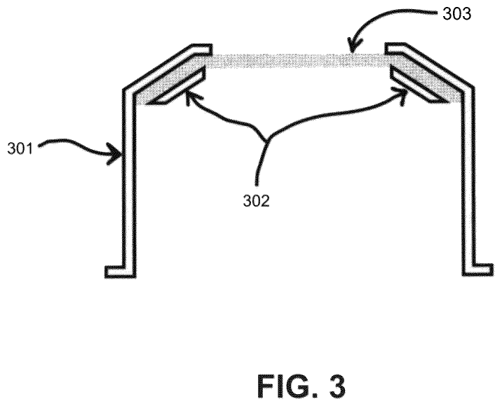

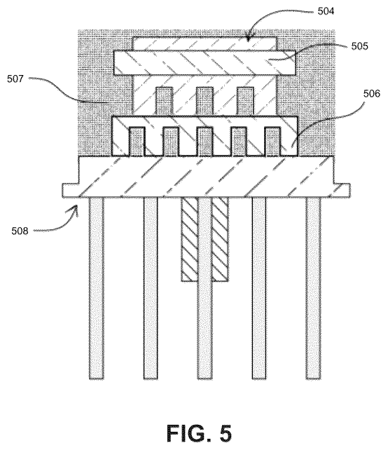

FIG. 3 illustrates an endcap 301 including an aerogel 303. The aerogel window 303 may be attached to the endcap 301. The aerogel window 303 may be attached to the endcap 301 on an interior surface of the endcap 301. In an example, the aerogel window 303 is attached to the endcap 301 using an adhesive. In an example, the aerogel window 303 is attached to the endcap 301 using a mechanical attachment means, such as clips, struts, a lip, or other means. The aerogel window 303 may span an opening in the endcap 301 to allow for X-ray transmission through the aerogel window 303 while closing the opening in the endcap 301. A desiccant 302 may be provided within the endcap 301. In an example, the desiccant 302 is attached to the aerogel window 303. The desiccant 302 may prevent water from forming ice on a sensor when the endcap 301 is included in an X-ray detector, as illustrated in FIG. 5.

In some implementations, the aerogel window 303 is a composite material including additional X-ray transparent materials. In an example, a thin film is deposited or placed over the aerogel window 303 to prevent moisture from being absorbed by the aerogel window 303. The aerogel window 303 may be treated with waterproofing agents during the gel formation process to enhance moisture resistance and prevent water absorption that could compromise thermal insulation performance. Chemical reagents such as trimethylchlorosilane (TMCS) or hexamethyldisilazane (HMDS) may be added to the gel precursor solution or applied to the formed gel before supercritical drying to introduce hydrophobic functional groups on the aerogel surface, creating a waterproof barrier that repels moisture while maintaining the desired X-ray transmission and thermal insulation properties.

The aerogel window 303 may be a silica-based aerogel, carbon-based aerogel, metal oxide-based aerogel, and/or polymer-based aerogel. The aerogel window 303 may have a thermal conductivity between 0.01 W/m·K and 0.03 W/m·K. The low thermal conductivity of the aerogel window 303 reduces thermal bridging between the interior components of an X-ray detector and an environment of the X-ray detector.

The aerogel window 303 can withstand operational temperature of the X-ray detector without degradation. In an example, the aerogel window 303 can withstand temperatures between ten and one hundred degrees Celsius. The aerogel window 303 may have a density between 0.00011 g/cm3 and 0.02 g/cm3.

A thickness of the aerogel window 303 may be between 0.2 mm and 1 mm. In some implementations, the thickness of the aerogel window 303 is greater than 1 mm. The thickness and density of the aerogel window 303 may be selected for a specific implementation as a balance between thermal insulation and X-ray transparency.

While the endcap 301 is discussed as including the aerogel window 303, the endcap 301 may include other windows of other thermally insulating materials that allow for X-ray transmission. For example, the endcap 301 may include a window formed from polyimide film, which provides good thermal insulation properties while maintaining X-ray transparency, particularly for higher energy X-rays above 1 keV. The polyimide film may have a thickness between 5 and 25 microns and may be coated with a thin aluminum layer to enhance its thermal insulation properties without significantly compromising X-ray transmission. In another example, the endcap 301 may incorporate a diamond window, which offers exceptional thermal insulation combined with superior mechanical strength and excellent X-ray transmission. The diamond window may be formed using chemical vapor deposition (CVD) techniques to create a thin film with thickness ranging from 0.3 to 5 microns, providing thermal conductivity values comparable to aerogel while offering enhanced durability in harsh operating environments. These alternative window materials may be selected based on specific application requirements, such as operating temperature range, mechanical stress conditions, or particular X-ray energy detection ranges needed for the detector assembly.

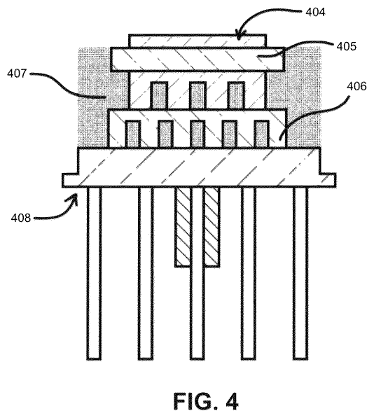

FIG. 4 illustrates an X-ray detector including an aerogel insulator 407 to insulate a thermoelectric cooler (TEC) 406 of the X-ray detector. The X-ray detector includes a header 408, the TEC 406, an electronic substrate 405, a sensor 404, and the aerogel insulator 407. The aerogel insulator 407 encapsulates the TEC 406. In some implementations, the aerogel insulator 407 encapsulates the electronic substrate 405 or sides of the electronic substrate 405. The aerogel insulator 407 does not contact the sensor 404 in this embodiment such that a capacitance of the aerogel insulator 407 does not affect measurements taken by the sensor 404.

The aerogel insulator 407 may be provided within the X-ray detector by pouring or dispensing a precursor gel or solution into the X-ray detector to cover the interior components of the X-ray detector and drying the precursor gel to form the aerogel insulator 407 encapsulating the TEC 406. The precursor gel may be poured within an endcap, or housing (not shown) of the X-ray detector. In this way, the TEC 406 is insulated by the aerogel insulator 407. In some implementations, the aerogel insulator 407 is inserted in the X-ray detector as a flexible sheet or blanket to surround the TEC 406.

FIG. 5 illustrates an X-ray detector including an aerogel insulator 507 to insulate a thermoelectric cooler (TEC) 506 of the X-ray detector, according to one embodiment of the present disclosure.

The X-ray detector includes a sensor 504, an electronic substrate 505, the TEC 506, the aerogel insulator 507, and a header 508. The aerogel insulator 507 may be positioned to encapsulate the TEC and other electronic components while providing thermal insulation. In some implementations, the aerogel insulator 507 may be formed using a molding process that allows for precise control over the shape and dimensions of the insulator.

The aerogel insulator 507 may be formed by first providing a gel solution within a mold that surrounds or encompasses the desired shape of the insulator. The mold may be configured to define the specific geometry needed to fit within an endcap or other housing and around the electronic components of the X-ray detector. The gel solution may be a precursor solution containing silica, metal oxide, polymer, or carbon-based materials that will form the aerogel structure. After dispensing the gel solution into the mold, the solution may be allowed to age under controlled conditions to form a gel network. This aging process may involve maintaining specific temperature and humidity conditions to promote proper gelation and cross-linking of the gel structure.

Following the aging process, the formed gel may undergo a supercritical drying process to create the aerogel insulator 507. The supercritical drying process may involve replacing the liquid within the gel pores with a supercritical fluid, such as supercritical carbon dioxide, which can be removed without causing the gel structure to collapse. This process preserves the low-density, highly porous structure characteristic of aerogels while maintaining the desired thermal insulation properties. The resulting aerogel insulator 507 may then be removed from the mold and integrated into the X-ray detector assembly, providing effective thermal insulation for the TEC 506 and other components while allowing X-ray transmission through its structure.

The mold may be removed after the aging process but before the supercritical drying process, as the aged gel becomes self-supporting and maintains its structural integrity without external support. Once the gel solution has undergone sufficient aging and cross-linking, the resulting gel network develops adequate mechanical strength to retain its shape and dimensions. In some implementations, the mold may be designed as a removable or breakaway structure that can be disassembled or dissolved without damaging the aged gel. The self-supporting nature of the aged gel allows for easier handling during subsequent processing steps and may facilitate more uniform supercritical drying by eliminating potential interference from mold materials. This approach may also reduce manufacturing complexity and costs by allowing mold reuse and eliminating the need for mold-compatible materials that can withstand the supercritical drying conditions.

The mold may be fabricated in various configurations to accommodate different detector geometries and application requirements, providing flexibility in the final shape of the aerogel insulator 507. In some implementations, the mold may be designed with complex three-dimensional geometries that conform to specific detector layouts, such as cylindrical shapes for round detector housings or rectangular configurations for compact detector assemblies. The mold may also incorporate features such as channels, cavities, or recesses to create aerogel insulators with customized thermal pathways or to accommodate specific electronic components within the detector assembly. For example, the mold may be formed with stepped or tiered sections to create an aerogel insulator 507 that provides varying insulation thicknesses in different regions of the detector, allowing for optimized thermal management in areas with different heat generation characteristics. In another example, the mold may include curved or angled surfaces to produce an aerogel insulator 507 that fits around irregularly shaped components or follows the contours of a detector housing with non-standard geometry. The mold may be manufactured using various techniques such as 3D printing, machining, or casting, enabling the creation of aerogel insulators with precise dimensions and complex shapes tailored to specific detector applications.

The aerogel insulator 507 may be modified after formation to achieve desired dimensions or configurations for specific detector applications. In some implementations, the aerogel insulator 507 may be cut using precision cutting tools such as laser cutting systems, ultrasonic cutting devices, or sharp blades to remove excess material or create specific shapes that conform to detector housing requirements. The aerogel insulator 507 may also be subjected to ablation processes, such as laser ablation or plasma ablation, to selectively remove material from targeted areas and create precise cavities, channels, or surface features. In some cases, mechanical grinding or sanding may be employed to reduce the thickness of the aerogel insulator 507 or to smooth surface irregularities that may have formed during the molding and drying processes. The aerogel insulator 507 may be trimmed or shaped using heated cutting tools that can cleanly separate the aerogel material without causing excessive cracking or structural damage. Additionally, chemical etching processes may be used to selectively dissolve portions of the aerogel insulator 507, allowing for the creation of complex internal geometries or the removal of material from areas where precise tolerances are required. These post-formation modification techniques may enable the aerogel insulator 507 to be customized for specific detector configurations while maintaining the thermal insulation properties and structural integrity of the aerogel insulator 507.

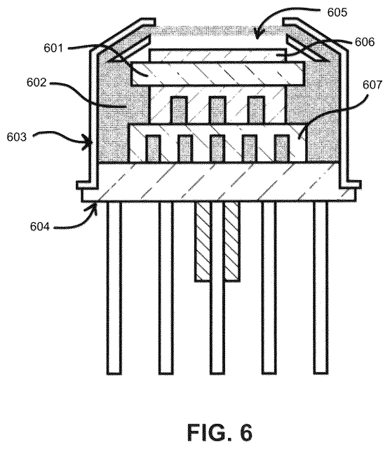

FIG. 6 illustrates an X-ray detector, according to one embodiment, coupled to an endcap 603, according to one embodiment. For example, the X-ray detector of FIG. 4 can be coupled to the endcap of FIG. 3. The X-ray detector includes a header 604, an endcap 603, a TEC 607, an electronic substrate 601, a sensor 606, and an aerogel insulator 602. The endcap 603 may be the endcap 301 of FIG. 3 and the aerogel insulator 602 may include the aerogel window 303 of FIG. 3. The aerogel insulator 602 insulates the TEC 607 without contacting the sensor 606. To insulate the sensor 606, the aerogel window of the endcap 603 is provided over the sensor 606 with a gap 605 between the sensor 606 and the aerogel window. In this way, the sensor is insulated without contacting the aerogel insulator 602 or the aerogel window. The desiccant on the interior of the aerogel window prevents water from icing onto the sensor 606.

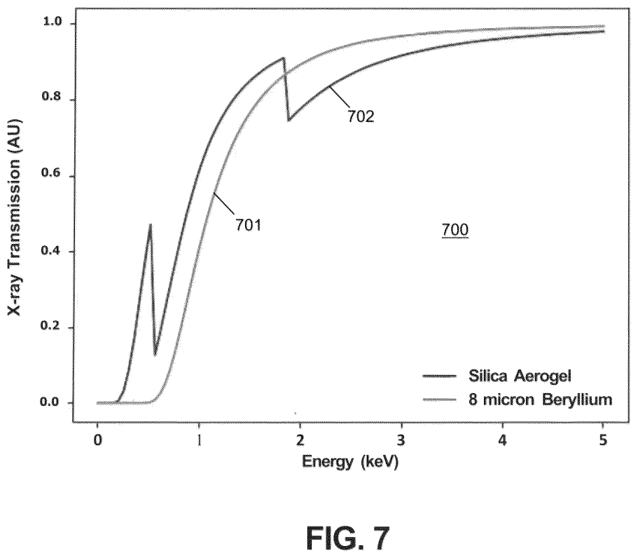

FIG. 7 is a chart 700 comparing X-ray transmission of an example aerogel sample 702 and beryllium 701. X-ray transmission refers to the transmission of X-rays through an object, such as the aerogel sample 702 and beryllium 701. Various properties of materials affect X-ray transmission, such as density and atomic number of constituent elements. X-ray transmission characteristics, such as changes in X-ray transmission at different energies, are visible in a transmission spectrum, such as the spectrum portion shown in the chart 700. The aerogel sample is a silica aerogel with a density of 0.003 g/cm3 and a thickness (between sensor and X-ray source) of 0.5 mm for the energy range of 0.01 keV to 5.0 keV compared to 8 micron beryllium.

The aerogel sample 702 demonstrates superior X-ray transmission compared to the 8 micron beryllium 701 across most of the energy spectrum shown in the chart 700. At lower energies below approximately 1.5 keV, the silica aerogel exhibits significantly higher transmission values, with the aerogel reaching transmission levels above 0.8 AU while the beryllium remains below 0.6 AU in this range. The aerogel sample 702 shows a characteristic absorption edge feature around 1.8 keV, which corresponds to silicon K-edge absorption, but even with this absorption feature, the aerogel maintains competitive transmission performance.

In the mid-energy range from approximately 2 keV to 4 keV, both materials show comparable transmission, with both the aerogel sample 702 and beryllium 701 approaching similar transmission values near 1.0 AU. At higher energies above 4 keV, both materials demonstrate nearly equivalent transmission performance, reaching maximum transmission values close to 1.0 AU.

The superior low-energy transmission of the aerogel sample 702 may be attributed to its extremely low density of 0.003 g/cm³, which results in reduced photoelectric absorption compared to the denser beryllium material. The 0.5 mm thickness of the aerogel provides sufficient structural integrity while maintaining excellent X-ray transparency. This combination of low density and optimized thickness allows the aerogel to achieve better overall transmission performance than the 8 micron beryllium across the critical low-energy range where many characteristic X-ray lines of light elements are detected, making it particularly advantageous for energy dispersive X-ray spectroscopy applications.

Table 1 shows the density and thickness (between sensor and X-ray source) for an aerogel sample to have X-ray transmission approximately equivalent to that of 8 micron beryllium.

TABLE 1

| Density (g/cm3) | Thickness (mm) |
|---|---|
| 0.0015 | 1 |
| 0.003 | 0.5 |
| 0.007 | 0.2 |

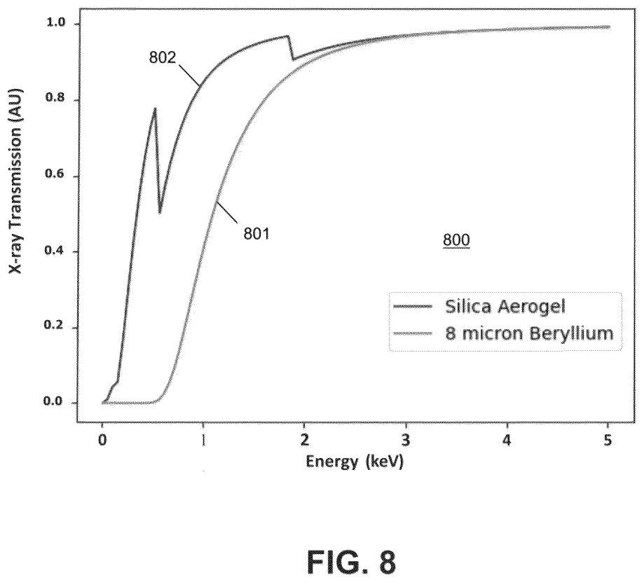

FIG. 8 is a chart 800 comparing X-ray transmission of another example aerogel sample 802 and beryllium 801. The aerogel sample is a silica aerogel with a density of 0.001 g/cm3 and a thickness (between sensor and X-ray source) of 0.5 mm for the energy range of 0.01 keV to 5.0 keV compared to 8 micron beryllium. Improved X-ray transmission in FIG. 7 as compared to FIG. 6 shows that decreasing the density of the aerogel results in improved X-ray transmission. Similarly, decreasing the thickness of the aerogel results in improved X-ray transmission.

The aerogel sample 802 in FIG. 8 demonstrates enhanced X-ray transmission performance compared to the 8 micron beryllium 801 due to its significantly reduced density of 0.001 g/cm³. This ultra-low density results in fewer atoms per unit volume available to interact with incoming X-ray photons, thereby reducing photoelectric absorption events that would otherwise attenuate the X-ray beam. The aerogel sample 802 exhibits superior transmission particularly in the low-energy region below 2 keV, where photoelectric absorption effects are most pronounced.

The improved performance of the aerogel sample 802 relative to beryllium 801 may be observed across the entire energy spectrum, with the aerogel maintaining transmission values consistently above those of beryllium throughout most of the measured range. At energies below 1 keV, the aerogel sample 802 shows transmission values approaching 0.9 AU, while the beryllium 801 exhibits significantly lower transmission in this critical energy range. This enhanced low-energy transmission makes the aerogel particularly suitable for detecting characteristic X-ray lines from light elements, which typically occur in the lower energy ranges.

The aerogel sample 802 also demonstrates reduced absorption edge effects compared to beryllium, resulting in smoother transmission across the energy spectrum. While beryllium exhibits absorption edges that create discontinuities in its transmission curve, the aerogel's silicon-based composition and extremely low density minimize these effects, providing more consistent transmission performance. The 0.5 mm thickness of the aerogel sample 802, combined with its ultra-low density, achieves an optimal balance between structural integrity and X-ray transparency, allowing it to outperform the thinner 8 micron beryllium window across the measured energy range.

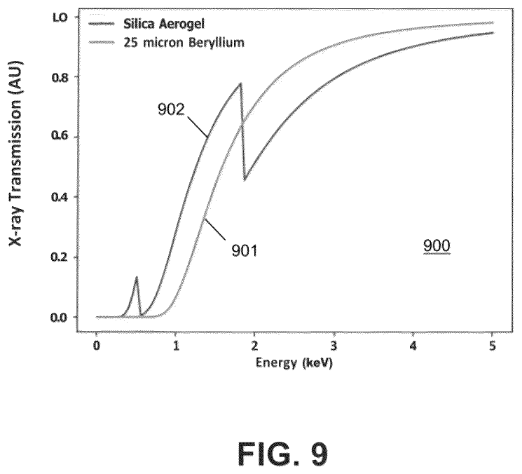

FIG. 9 is a chart 900 comparing X-ray transmission of another example aerogel sample 902 and beryllium 901. The aerogel sample is a silica aerogel with a density of 0.008 g/cm3 and a thickness (between sensor and X-ray source) of 0.5 mm for the energy range of 0.01 keV to 5.0 keV compared to 25 micron beryllium. The increased density of the aerogel relative to the aerogel of FIGS. 6 and 7 provides greater structural integrity at the cost of reduced X-ray transmission, similar to how the thicker beryllium provides greater structural integrity at the cost of reduced X-ray transmission.

The aerogel sample 902 in FIG. 9 demonstrates competitive X-ray transmission performance compared to the 25 micron beryllium 901, despite having a higher density of 0.008 g/cm³ than the previous aerogel samples. The increased thickness of the beryllium from 8 microns to 25 microns results in significantly reduced transmission, particularly in the lower energy ranges where photoelectric absorption is most significant. This thicker beryllium configuration exhibits substantially lower transmission values below 2 keV compared to the aerogel sample 902.

The aerogel sample 902 maintains superior transmission performance in the critical low-energy region below 1.5 keV, where many characteristic X-ray lines of light elements are detected. In this energy range, the aerogel achieves transmission values that may exceed those of the 25 micron beryllium by significant margins, with the aerogel reaching transmission levels above 0.7 AU while the thicker beryllium remains considerably lower. The aerogel's silicon-based composition continues to provide advantages over beryllium in terms of reduced photoelectric absorption cross-sections for low-energy X-rays.

In the mid-energy range from approximately 2 keV to 4 keV, both materials show more comparable transmission, with the aerogel sample 902 maintaining competitive or superior performance relative to the 25 micron beryllium 901. The aerogel's 0.5 mm thickness, while greater than the beryllium thickness, is offset by its significantly lower density, resulting in fewer absorbing atoms per unit area along the X-ray path.

At higher energies above 4 keV, both materials approach similar transmission values near 1.0 AU, demonstrating that the aerogel can achieve equivalent high-energy transmission performance while providing superior low-energy characteristics. The aerogel sample 902 represents a practical compromise between structural integrity and X-ray transparency, offering enhanced mechanical properties compared to lower-density aerogel formulations while maintaining transmission advantages over thicker beryllium windows that may be required for similar structural applications.

Table 2 shows the density and thickness (between sensor and X-ray source) for an aerogel sample to have X-ray transmission approximately equivalent to that of 25 micron beryllium.

TABLE 2

| Density (g/cm³) | Thickness (mm) |
|---|---|
| 0.004 | 1 |
| 0.008 | 0.5 |
| 0.02 | 0.2 |

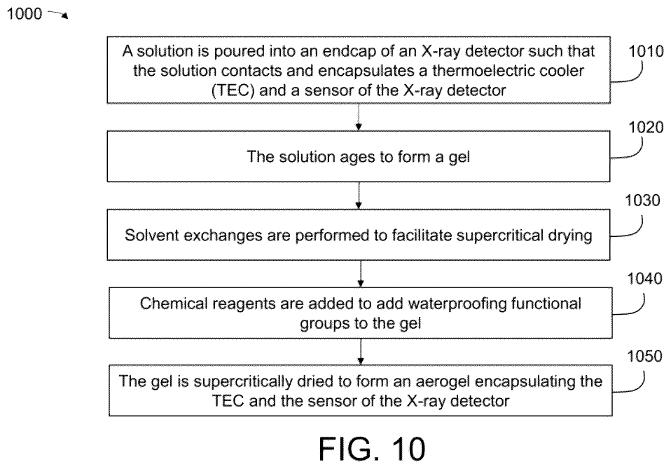

FIG. 10 is a flow diagram illustrating operations of a method 1000 for manufacturing an X-ray detector including an aerogel insulator. The method 1000 may include additional, fewer, or different operations than shown.

At operation 1010, a solution is poured into an endcap of an X-ray detector such that the solution contacts and encapsulates a thermoelectric cooler (TEC) and a sensor of the X-ray detector. The solution may be dispensed as a liquid precursor that flows around and covers the electronic components within the detector housing. In some implementations, the solution may be a silica-based precursor containing tetraethyl orthosilicate (TEOS) dissolved in ethanol with water and an acid catalyst. In another example, the solution may be a polymer-based precursor comprising resorcinol and formaldehyde in water with sodium carbonate as a catalyst. The solution may be poured in a controlled manner to ensure complete coverage of the TEC while avoiding air bubbles that could compromise the insulation properties. The dispensing process may be performed at room temperature or under controlled temperature conditions to optimize gelation kinetics.

At operation 1020, the solution ages to form a gel. The aging process may involve maintaining the solution under controlled environmental conditions for a predetermined time period to allow cross-linking reactions to occur. In some cases, the aging may be performed at temperatures between 40° C. and 80° C. for periods ranging from several hours to several days. For example, a silica-based solution may be aged at 60° C. for 24 hours to achieve optimal gel strength and pore structure. In another implementation, a polymer-based solution may be aged at 85° C. for 72 hours to promote complete polymerization and network formation. The aging process may be conducted in a sealed environment to prevent solvent evaporation and maintain consistent gel properties throughout the volume.

At operation 1030, solvent exchanges are performed to facilitate supercritical drying. The solvent exchange process may involve replacing the original solvent within the gel pores with a solvent that is more compatible with supercritical drying conditions. In some implementations, the gel may be immersed in successive baths of ethanol to replace water within the pore structure. For example, the gel may undergo three sequential ethanol exchanges, each lasting 24 hours, to ensure complete water removal. In another approach, the gel may be subjected to acetone exchanges followed by liquid carbon dioxide exchanges to prepare for supercritical drying with carbon dioxide. The exchange process may be performed at controlled temperatures to maintain gel integrity while achieving efficient solvent replacement.

At operation 1040, chemical reagents are added to add waterproofing functional groups to the gel. The waterproofing treatment may involve introducing hydrophobic surface modifications to prevent moisture absorption in the final aerogel product. In some cases, trimethylchlorosilane (TMCS) may be added to the gel to create hydrophobic silyl groups on the surface of silica networks. For example, the gel may be treated with a solution containing 10% TMCS in hexane for 24 hours to achieve surface modification. In another implementation, hexamethyldisilazane (HMDS) may be used as a waterproofing agent, with the gel being exposed to HMDS vapor at elevated temperatures. The waterproofing process may be performed under inert atmosphere conditions to prevent unwanted side reactions and ensure uniform surface treatment.

At operation 1050, the gel is supercritically dried to form an aerogel encapsulating the TEC and the sensor of the X-ray detector. The supercritical drying process may involve replacing the liquid within the gel pores with a supercritical fluid that can be removed without causing pore collapse. In some implementations, liquid carbon dioxide may be used as the supercritical fluid, with the drying performed at temperatures above 31° C. and pressures above 73.8 bar. For example, the gel may be placed in a supercritical drying chamber and subjected to carbon dioxide at 40° C. and 100 bar for several hours until complete solvent removal is achieved. In another approach, supercritical ethanol may be used at temperatures above 243° C. and pressures above 63 bar to directly dry alcohol-exchanged gels. The supercritical drying process may be controlled to maintain gradual pressure release to prevent structural damage to the aerogel network.

In some implementations, operations 1030 and 1040 may be optional and may not be performed depending on the specific requirements of the detector application and the characteristics of the gel precursor system. The solvent exchange process of operation 1030 may facilitate more efficient supercritical drying by replacing solvents that are less compatible with the supercritical fluid, but direct supercritical drying of the original gel may be feasible in certain cases where the initial solvent system is already suitable for the chosen supercritical drying conditions. Similarly, the waterproofing treatment of operation 1040 may enhance the moisture resistance and long-term stability of the aerogel insulator, but may not be necessary in applications where the detector operates in controlled environments with low humidity or where the aerogel composition inherently provides adequate moisture resistance. The decision to include or omit these operations may depend on factors such as the intended operating environment, cost considerations, processing time constraints, and the specific performance requirements of the X-ray detector system.

The method 1000 may including grinding, ablating, or otherwise removing a portion of the aerogel insulator such that a thickness of the aerogel insulator above the sensor matches the target thickness. For example, precision laser ablation may be employed to carefully remove excess aerogel material layer by layer until the desired thickness is achieved, which allows for highly controlled removal without introducing mechanical stress that could damage the delicate aerogel structure. In another example, mechanical grinding using specialized fine-grit abrasive tools may be utilized to gradually reduce the aerogel thickness to the target specification, with periodic thickness measurements performed using non-contact optical methods to ensure accuracy. The thickness adjustment process may also include chemical etching techniques, wherein specific solvents or reagents are applied to selectively dissolve portions of the aerogel structure until the target thickness is reached. During these thickness adjustment processes, care must be taken to maintain the structural integrity and insulating properties of the aerogel while achieving the precise dimensions required for optimal X-ray transmission and thermal insulation performance in the final detector assembly.

The method 1000 may include rendering the aerogel insulator opaque to visible light to prevent optical interference with the detector sensor. In some implementations, the aerogel may not be completely opaque to visible light in certain formulations, which could potentially affect sensor performance by introducing unwanted optical noise. To address this, a light blocking material may be incorporated into or deposited onto the aerogel insulator. For example, a thin layer of carbon nanotubes may be deposited on the surface of the aerogel to provide effective visible light blocking while maintaining X-ray transparency. The carbon nanotube layer may be deposited using various techniques such as spray coating, dip coating, or chemical vapor deposition to create a uniform light-blocking barrier. In some cases, the carbon nanotube layer may have a thickness between 10 nanometers and 1 micrometer to achieve adequate light blocking without significantly impeding X-ray transmission.

Alternatively, the aerogel insulator may be formulated with chemical compositions that inherently provide visible light opacity while preserving X-ray transmission. The aerogel precursor solution may be modified to include functional groups or additives that selectively absorb visible light wavelengths. For instance, organic chromophores or metal oxide nanoparticles may be incorporated into the aerogel matrix during the gelation process to create light-absorbing centers within the aerogel structure. These functional groups may be selected to have strong absorption in the visible spectrum while having minimal interaction with X-ray photons due to their higher energy. In some implementations, the aerogel may be doped with materials such as iron oxide nanoparticles or organic dyes that provide the desired optical properties. The concentration of these light-blocking additives may be optimized to achieve effective visible light attenuation while maintaining the low density and thermal insulation properties of the aerogel insulator.

An example of an X-ray detector including an aerogel insulator manufactured according to the method 1000 is the X-ray detector of FIG. 2.

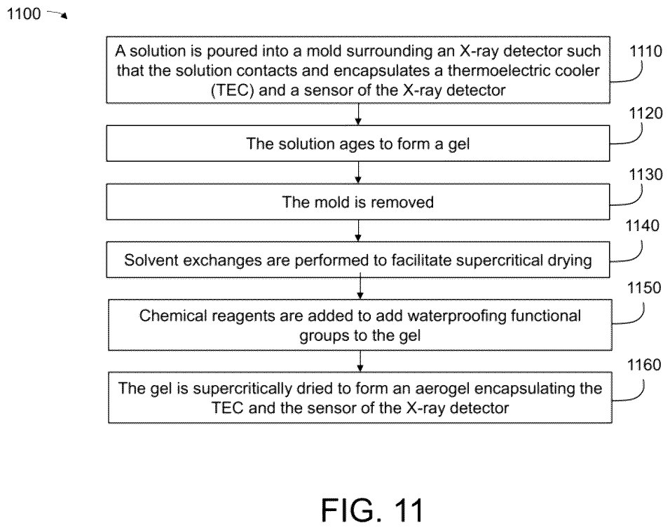

FIG. 11 illustrates a flow diagram illustrating operations of a method 1100 for manufacturing an X-ray detector including an aerogel insulator using a mold, according to one embodiment of the present disclosure. The method 1100 may include additional, fewer, or different operations than shown.

At operation 1110, a solution is poured into a mold surrounding an X-ray detector such that the solution contacts and encapsulates a thermoelectric cooler (TEC) and a sensor of the X-ray detector. The solution may be dispensed as a liquid precursor that flows around the detector components while being contained within the mold structure. In some implementations, the solution may be a silica-based precursor containing tetraethyl orthosilicate dissolved in methanol with water and a base catalyst such as ammonium hydroxide. In another example, the solution may be a resorcinol-formaldehyde precursor mixed with deionized water and sodium carbonate as a polymerization catalyst. The mold may be configured to define specific geometries around the detector assembly, allowing for precise control over the final aerogel shape and thickness. The pouring process may be performed under controlled atmospheric conditions to minimize contamination and ensure uniform distribution of the precursor solution throughout the mold cavity.

At operation 1120, the solution ages to form a gel. The aging process may involve maintaining the solution within the mold under controlled temperature and humidity conditions for a predetermined duration to promote gelation and cross-linking reactions. In some cases, the aging may be conducted at temperatures between 50° C. and 90° C. for periods ranging from 12 hours to 96 hours depending on the precursor chemistry. For example, a silica-based solution may be aged at 70° C. for 48 hours to develop optimal gel strength and pore structure within the mold. In another implementation, a polymer-based solution may be aged at 80° C. for 36 hours to achieve complete network formation while maintaining the desired mold geometry. The aging environment may be maintained with controlled humidity levels to prevent premature solvent evaporation that could affect gel uniformity.

At operation 1130, the mold is removed. The mold removal process may be performed after the gel has achieved sufficient structural integrity to maintain its shape without external support. In some implementations, the mold may be designed as a multi-part assembly that can be disassembled without damaging the aged gel structure. For example, the mold may comprise separable sections that are removed sequentially to expose different portions of the formed gel. In another approach, the mold may be fabricated from a dissolvable material that can be chemically removed using appropriate solvents that do not affect the gel network. The removal process may be conducted at controlled temperatures to prevent thermal shock that could cause cracking or structural damage to the gel.

At operation 1140, solvent exchanges are performed to facilitate supercritical drying. The solvent exchange process may involve sequential immersion of the gel in different solvents to replace the original pore liquid with a fluid more suitable for supercritical drying. In some implementations, the gel may undergo a series of ethanol exchanges to remove residual water from the pore structure. For example, the gel may be immersed in three successive ethanol baths, each maintained for 12 hours, to achieve complete water displacement. In another approach, the gel may be subjected to acetone exchanges followed by liquid carbon dioxide infiltration to prepare for carbon dioxide supercritical drying. The exchange process may be performed at ambient temperature with gentle agitation to promote efficient mass transfer while preserving gel integrity.

At operation 1150, chemical reagents are added to add waterproofing functional groups to the gel. The waterproofing treatment may involve surface modification reactions that introduce hydrophobic groups to prevent moisture absorption in the final aerogel. In some cases, the gel may be treated with silylating agents such as trimethylchlorosilane to create hydrophobic surface terminations. For example, the gel may be exposed to a solution containing 5% trimethylchlorosilane in toluene for 18 hours to achieve surface hydrophobization. In another implementation, the gel may be treated with hexamethyldisiloxane vapor at elevated temperatures to introduce hydrophobic siloxane groups. The waterproofing process may be conducted under anhydrous conditions to prevent competing hydrolysis reactions that could reduce treatment effectiveness.

At operation 1160, the gel is supercritically dried to form an aerogel encapsulating the TEC and the sensor of the X-ray detector. The supercritical drying process may involve controlled removal of the pore liquid using supercritical fluid conditions to preserve the gel's porous structure. In some implementations, supercritical carbon dioxide may be used at temperatures above 31° C. and pressures above 74 bar to extract the pore liquid without causing structural collapse. For example, the gel may be processed in a supercritical drying apparatus at 45° C. and 120 bar for 4 hours to achieve complete liquid removal. In another approach, supercritical ethanol may be employed at temperatures above 243° C. and pressures above 63 bar for direct drying of alcohol-exchanged gels. The drying process may include gradual pressure reduction phases to prevent rapid decompression that could damage the aerogel structure.

In some implementations, operations 1140 and 1150 may be optional and may not be performed depending on the specific requirements of the detector application and the characteristics of the gel precursor system. The solvent exchange process of operation 1140 may facilitate more efficient supercritical drying by replacing solvents that are less compatible with the supercritical fluid, but direct supercritical drying of the original gel may be feasible in certain cases where the initial solvent system is already suitable for the chosen supercritical drying conditions. Similarly, the waterproofing treatment of operation 1150 may enhance the moisture resistance and long-term stability of the aerogel insulator, but may not be necessary in applications where the detector operates in controlled environments with low humidity or where the aerogel composition inherently provides adequate moisture resistance. The decision to include or omit these operations may depend on factors such as the intended operating environment, cost considerations, processing time constraints, and the specific performance requirements of the X-ray detector system.

The method 1100 may include grinding, ablating, or otherwise removing a portion of the aerogel insulator such that a thickness of the aerogel insulator above the sensor matches the target thickness. For example, precision laser ablation may be employed to carefully remove excess aerogel material layer by layer until the desired thickness is achieved, which allows for highly controlled removal without introducing mechanical stress that could damage the delicate aerogel structure. In another example, mechanical grinding using specialized fine-grit abrasive tools may be utilized to gradually reduce the aerogel thickness to the target specification, with periodic thickness measurements performed using non-contact optical methods to ensure accuracy. The thickness adjustment process may also include chemical etching techniques, wherein specific solvents or reagents are applied to selectively dissolve portions of the aerogel structure until the target thickness is reached. During these thickness adjustment processes, care must be taken to maintain the structural integrity and insulating properties of the aerogel while achieving the precise dimensions required for optimal X-ray transmission and thermal insulation performance in the final detector assembly.

An example of an X-ray detector including an aerogel insulator manufactured according to the method 1100 is the X-ray detector of FIG. 5. The aerogel insulator 507 shown in FIG. 5 may be formed by dispensing a gel solution into a mold that surrounds the detector components, allowing the solution to age within the mold to form a gel structure, and then removing the mold before performing supercritical drying to create the final aerogel insulator 507. The molding process may enable precise control over the shape and dimensions of the aerogel insulator 507, allowing it to conform to the specific geometry of the 506 and provide effective thermal insulation around the electronic components while maintaining the desired thickness and structural properties for optimal detector performance.

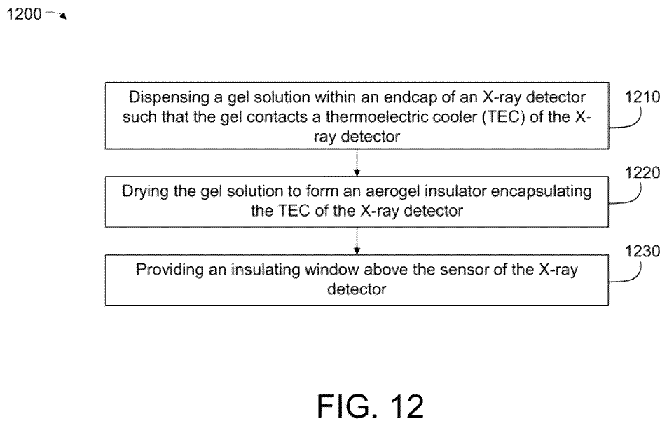

FIG. 12 is a flow diagram illustrating operations of a method 1200 for manufacturing an X-ray detector including an aerogel insulator and an insulating window. The method 1200 may include additional, fewer, or different operations than shown.

At operation 1210, gel is dispensed within an endcap of an X-ray detector such that the gel contacts a TEC of the X-ray detector. The X-ray detector may be a fully-assembled X-ray detector. The gel may be a precursor gel for an aerogel. The gel may a gel solution that has low viscosity relative to the gel once cross-linking reactions have occurred. The gel may fill an interior volume of the X-ray detector to cover and encapsulate the TEC of the X-ray detector. Dispensing the gel may include dispensing an amount of the gel such that the gel encapsulates the TEC but does not contact a sensor of the X-ray detector to prevent a capacitance of the resulting aerogel from affecting the sensor. The gel solution may be dispensed as a liquid precursor containing silica-based materials such as tetraethyl orthosilicate dissolved in ethanol with water and an acid catalyst. In another example, the gel solution may comprise polymer-based precursors such as resorcinol and formaldehyde in water with sodium carbonate as a catalyst. The dispensing process may be performed at controlled temperatures to optimize gelation kinetics and ensure uniform coverage of the TEC components.

At operation 1220, the gel is dried to form an aerogel insulator encapsulating the TEC of the X-ray detector. Drying the gel may include performing supercritical drying of the gel to prevent a loss of volume. In an example, liquid carbon dioxide is used to replace liquid in the gel with liquid carbon dioxide, which is maintained at pressure to perform supercritical drying of the gel. The drying process may involve aging the gel solution to form a gel network through cross-linking reactions that occur over a controlled time period before performing supercritical drying. For example, the gel may be aged at temperatures between 40° C. and 80° C. for periods ranging from 12 hours to 72 hours to achieve optimal gel strength and pore structure before performing supercritical drying. In another implementation, the gel may be aged at 60° C. for 24 hours to promote complete polymerization and network formation before performing supercritical drying. The supercritical drying may be performed using supercritical carbon dioxide at temperatures above 31° C. and pressures above 73.8 bar to extract pore liquid without causing structural collapse. In another approach, supercritical ethanol may be employed at temperatures above 243° C. and pressures above 63 bar for direct drying of alcohol-exchanged gels.

The aerogel insulator may comprise at least one of a silica-based aerogel, a carbon-based aerogel, a metal oxide-based aerogel, or a polymer-based aerogel. For example, the aerogel may be formed from silica precursors to create a silica-based aerogel with low thermal conductivity. In another example, the aerogel may be formed from resorcinol-formaldehyde precursors to create a carbon-based aerogel through pyrolysis processes. The aerogel insulator may have an X-ray transmission comparable to or better than an X-ray transmission of an eight-micron thick beryllium window. For instance, a silica aerogel with a density of 0.003 g/cm³ and a thickness of 0.5 mm may provide X-ray transmission equivalent to 8 micron beryllium across the energy range of 0.01 keV to 5.0 keV. In another example, a silica aerogel with a density of 0.0015 g/cm³ and a thickness of 1 mm may achieve similar X-ray transmission performance to 8 micron beryllium. The aerogel insulator may have a thermal conductivity between 0.01 W/m·K and 0.03 W/m·K and may be capable of withstanding operational temperatures of the X-ray detector. For example, the aerogel may exhibit thermal conductivity of 0.015 W/m·K while maintaining structural integrity at temperatures between 10° C. and 100° C. In another implementation, the aerogel may have thermal conductivity of 0.025 W/m·K and withstand operational temperatures up to 80° C. without degradation.

At operation 1230, an insulating window is provided above the sensor of the X-ray detector. In some implementations, the insulating window is an aerogel. In an example, the insulating window includes the same aerogel as the aerogel insulator. The insulating window may be provided with a gap between the sensor and the insulating window to prevent a capacitance of the insulating window from affecting the sensor. The insulating window may be attached to an endcap of the X-ray detector using adhesive materials or mechanical attachment means such as clips or struts. For example, the aerogel window may be secured to the interior surface of the endcap using a thermally stable adhesive that maintains bond strength at operational temperatures. In another implementation, the aerogel window may be held in place using mechanical clips or a lip structure formed in the endcap that provides secure positioning without requiring adhesives. The insulating window may span an opening in the endcap to allow for X-ray transmission while providing thermal insulation. For instance, the aerogel window may be positioned to cover a circular opening in the endcap with a diameter sized to accommodate the sensor field of view. In another example, the aerogel window may be configured as a rectangular panel that covers a square or rectangular opening in the endcap designed for specific detector geometries.

An example of an X-ray detector including an aerogel insulator manufactured according to the method 1200 is the X-ray detector of FIG. 5. The method 1200 enables the creation of various detector configurations that utilize aerogel insulation to replace traditional vacuum encapsulation systems. For example, the X-ray detector shown in FIG. 5 demonstrates how the aerogel insulator 507 can be formed by dispensing a gel solution within the 506 to encapsulate the thermoelectric cooler and other electronic components, followed by supercritical drying to create the final aerogel structure. In another example, the detector configuration may include an electronic substrate 505 positioned above the sensor to provide thermal insulation while maintaining X-ray transparency, with the aerogel window being manufactured using the same gel dispensing and drying process described in method 1200. These implementations demonstrate the versatility of the method 1200 in producing X-ray detectors with improved reliability and reduced manufacturing complexity compared to conventional vacuum-encapsulated systems.

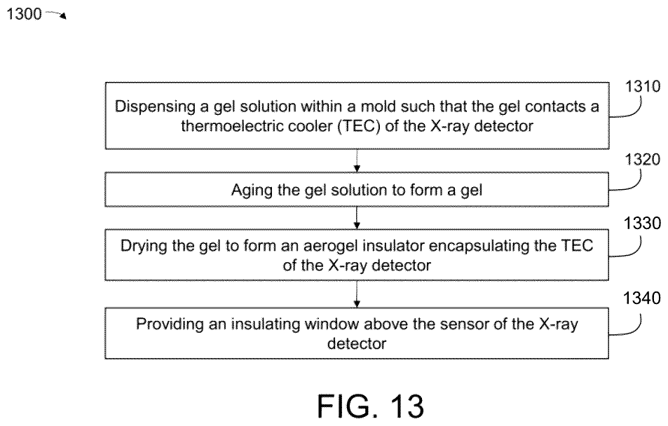

FIG. 13 is a flow diagram illustrating operations of a method for manufacturing an X-ray detector including an aerogel insulator formed within a mold and an insulating window, according to one embodiment of the present disclosure. The method 1300 may include additional, fewer, or different operations than shown.

At operation 1310, a gel solution is dispensed within a mold such that the gel contacts a thermoelectric cooler (TEC) of the X-ray detector. The gel solution may be poured or injected into a pre-formed mold that has been positioned around the X-ray detector components to define the desired shape and dimensions of the final aerogel insulator. The mold may be fabricated from materials such as silicone, plastic, or metal that can withstand the processing conditions and be easily removed after gel formation. The gel solution may be a silica-based precursor containing tetraethyl orthosilicate dissolved in ethanol with water and an ammonia catalyst to promote gelation. In another example, the gel solution may comprise a polymer-based precursor such as resorcinol and formaldehyde dissolved in water with sodium carbonate as a polymerization catalyst. The dispensing process may be performed at controlled temperatures between 20° C. and 40° C. to optimize flow characteristics and ensure complete filling of the mold cavity around the detector components.

The gel solution may contact both the TEC and a sensor of the X-ray detector, allowing the resulting aerogel insulator to encapsulate both components for comprehensive thermal insulation. For example, the gel solution may be dispensed to completely surround the TEC and flow around the sensor assembly to provide uniform insulation coverage. In another implementation, the gel solution may be carefully dispensed to fill the mold cavity such that it contacts the TEC housing and extends over the sensor surface to create a continuous insulating layer. The aerogel insulator formed from this process may comprise at least one of a silica-based aerogel, a carbon-based aerogel, a metal oxide-based aerogel, or a polymer-based aerogel depending on the precursor chemistry selected. For instance, a silica-based aerogel may be formed using tetraethyl orthosilicate precursors, while a carbon-based aerogel may be created from resorcinol-formaldehyde precursors followed by carbonization. The resulting aerogel insulator may have an X-ray transmission comparable to or better than an X-ray transmission of an eight-micron thick beryllium window, such as a silica aerogel with a density of 0.003 g/cm³ and thickness of 0.5 mm providing equivalent transmission performance. In another example, a silica aerogel with density of 0.0015 g/cm³ and thickness of 1 mm may achieve superior X-ray transmission compared to eight-micron beryllium. The aerogel insulator may have a thermal conductivity between 0.01 W/m·K and 0.03 W/m·K and may be capable of withstanding operational temperatures of the X-ray detector, such as maintaining thermal conductivity of 0.015 W/m·K while operating at temperatures between 10° C. and 100° C. In another implementation, the aerogel may exhibit thermal conductivity of 0.025 W/m·K and withstand operational temperatures up to 80° C. without structural degradation.

At operation 1320, the gel solution is aged to form a gel within the mold. The aging process may involve maintaining the gel solution under controlled environmental conditions for a predetermined time period to allow cross-linking reactions to occur and develop the gel network structure. The aging may be performed at temperatures between 50° C. and 90° C. for periods ranging from 12 hours to 96 hours depending on the specific precursor chemistry and desired gel properties. For example, a silica-based gel solution may be aged at 70° C. for 48 hours to achieve optimal gel strength and pore structure development. In another implementation, a polymer-based gel solution may be aged at 80° C. for 36 hours to promote complete polymerization and network formation while maintaining the mold geometry. The aging environment may be maintained with controlled humidity levels to prevent premature solvent evaporation that could affect gel uniformity and structural integrity.

At operation 1330, the gel is dried to form an aerogel insulator encapsulating the TEC of the X-ray detector, and an insulating window is provided above the sensor of the X-ray detector. The drying process may include supercritical drying to preserve the porous structure of the gel and prevent volume shrinkage that would occur with conventional drying methods. The supercritical drying may be performed using supercritical carbon dioxide at temperatures above 31° C. and pressures above 73.8 bar to extract pore liquid without causing structural collapse. For example, the gel may be processed in a supercritical drying chamber at 45° C. and 120 bar for 4 hours to achieve complete liquid removal while maintaining the aerogel structure. In another approach, supercritical ethanol may be employed at temperatures above 243° C. and pressures above 63 bar for direct drying of alcohol-exchanged gels. The insulating window may be an aerogel window that is separately manufactured and positioned above the sensor after the main aerogel insulator has been formed. For instance, the insulating window may be fabricated using the same gel precursor chemistry as the main insulator and attached to the detector endcap using thermally stable adhesives. In another example, the insulating window may be formed from a different aerogel composition optimized for X-ray transparency and secured using mechanical clips or mounting structures integrated into the detector housing.

At operation 1340, an insulating window is provided above the sensor of the X-ray detector. In some implementations, the insulating window is an aerogel. In an example, the insulating window includes the same aerogel as the aerogel insulator. The insulating window may be provided with a gap between the sensor and the insulating window to prevent a capacitance of the insulating window from affecting the sensor. The insulating window may be attached to an endcap of the X-ray detector using adhesive materials or mechanical attachment means such as clips or struts. For example, the aerogel window may be secured to the interior surface of the endcap using a thermally stable adhesive that maintains bond strength at operational temperatures. In another implementation, the aerogel window may be held in place using mechanical clips or a lip structure formed in the endcap that provides secure positioning without requiring adhesives. The insulating window may span an opening in the endcap to allow for X-ray transmission while providing thermal insulation. For instance, the aerogel window may be positioned to cover a circular opening in the endcap with a diameter sized to accommodate the sensor field of view. In another example, the aerogel window may be configured as a rectangular panel that covers a square or rectangular opening in the endcap designed for specific detector geometries.

The methods 1000, 1100, 1200, and 1300 may be performed at least in part using robotic systems or other automated systems to enable efficient mass production of aerogel-insulated X-ray detectors. Automated dispensing systems may be employed to precisely control the volume and placement of gel solutions within detector endcaps or molds, ensuring consistent coverage of thermoelectric coolers and other components while minimizing human error and variability between units. Robotic handling systems may manage the transfer of detector assemblies between processing stations, including aging chambers, solvent exchange baths, and supercritical drying equipment, while maintaining controlled environmental conditions throughout the manufacturing process. Automated mold positioning and removal systems may facilitate the precise placement of molds around detector components and their subsequent removal after gel formation, enabling consistent aerogel geometries across multiple units. Computer-controlled environmental chambers may regulate temperature, humidity, and atmospheric conditions during aging processes, while automated supercritical drying systems may manage pressure and temperature profiles to achieve optimal aerogel formation. Quality control systems incorporating automated thickness measurement, density verification, and X-ray transmission testing may ensure that each aerogel insulator meets specified performance criteria before final assembly. These automated manufacturing approaches may significantly reduce production time, improve consistency in aerogel properties, and enable the cost-effective production of large quantities of aerogel-insulated X-ray detectors for commercial applications.

The aerogel insulator can be the same across FIGS. 2-13, having the same or similar properties in terms of thermal conductivity, density, and X-ray transmission regardless of the specific detector configuration or manufacturing method employed (e.g., use of a mold or endcap to form the aerogel). This consistency enables standardized production processes and predictable performance across different detector designs. For example, a silica-based aerogel with a density of 0.003 g/cm³ and thermal conductivity of 0.015 W/m·K may be utilized in both the configuration shown in FIG. 2, where the aerogel insulator 202 encapsulates the entire detector assembly, and in the configuration shown in FIG. 6, where the aerogel insulator 602 specifically surrounds the TEC 607 without contacting the sensor 404. Similarly, the aerogel window 303 shown in FIG. 3 and the aerogel insulator 507 shown in FIG. 5 may be fabricated from identical precursor materials and processing conditions to achieve consistent X-ray transmission properties equivalent to 8-micron beryllium, despite their different physical arrangements within the detector assemblies. This material consistency across different detector configurations simplifies manufacturing logistics, reduces production costs, and ensures reliable performance characteristics regardless of which specific implementation approach is selected for a particular application.

In a specific implementation example, a silica-based aerogel insulator is formed directly within the endcap of an energy dispersive X-ray detector to replace conventional vacuum encapsulation. The detector assembly includes a silicon drift detector sensor mounted on a thermoelectric cooler within a cylindrical aluminum endcap having an internal diameter of 25 millimeters and a height of 15 millimeters.

The gel solution is prepared by combining tetraethyl orthosilicate with ethanol in a 1:4 molar ratio, followed by the addition of deionized water and hydrochloric acid catalyst to achieve a pH of 2.5. This precursor solution exhibits a viscosity of 2.1 centipoise at room temperature, allowing complete penetration around the detector components. The solution is dispensed directly into the assembled detector endcap using a precision syringe pump at a controlled flow rate of 0.5 milliliters per minute. The dispensing process fills the endcap volume completely, with the gel solution flowing around the thermoelectric cooler housing, wire bonds, and preamplifier components while covering the sensor surface with a uniform layer thickness of 0.6 millimeters.

Following dispensing, the gel solution undergoes aging at 65° C. for 36 hours within a humidity-controlled chamber maintained at 45% relative humidity. During this aging period, hydrolysis and condensation reactions create a three-dimensional silica network with interconnected pores averaging 15 nanometers in diameter. The aged gel exhibits sufficient mechanical strength to maintain its shape and position around the detector components without external support.

The aged gel then undergoes supercritical drying using carbon dioxide at 40° C. and 85 bar pressure for 6 hours. This process removes the pore liquid while preserving the nanoporous structure, resulting in a final aerogel insulator with a density of 0.0025 grams per cubic centimeter and thermal conductivity of 0.014 watts per meter-kelvin. The aerogel completely encapsulates the thermoelectric cooler and extends over the sensor with the predetermined 0.6 millimeter thickness.

In another specific implementation example, a polymer-based aerogel insulator is formed using a precision-molded approach for an energy dispersive X-ray detector assembly. The detector includes a silicon drift detector sensor and thermoelectric cooler positioned within a rectangular aluminum endcap measuring 30 millimeters in length, 20 millimeters in width, and 12 millimeters in height.

A custom silicone mold is fabricated with internal cavities that precisely conform to the detector geometry, including recessed channels that accommodate the thermoelectric cooler, wire bonds, and sensor assembly. The mold features a two-part design with separable upper and lower sections connected by alignment pins, enabling complete encapsulation of the detector components while providing access for gel solution dispensing through strategically positioned inlet ports.

The gel solution is prepared using resorcinol and formaldehyde precursors in a 1:2 molar ratio dissolved in deionized water, with sodium carbonate added as a catalyst to achieve a pH of 6.8. This formulation produces a solution with a viscosity of 1.8 centipoise at 25° C., ensuring optimal flow characteristics for complete mold filling. The solution is degassed under vacuum for 15 minutes to eliminate air bubbles that could compromise the final aerogel structure.

The assembled detector is positioned within the lower mold section, and the upper section is secured using precision clamps that maintain consistent pressure distribution. The gel solution is injected through the inlet ports using a computer-controlled dispensing system operating at 0.3 milliliters per minute, with real-time monitoring of fill levels through transparent viewing windows integrated into the mold walls. The controlled dispensing rate prevents air entrapment and ensures uniform distribution around all detector components, including complete infiltration into narrow spaces between wire bonds and electronic substrates.

The filled mold assembly undergoes aging at 75° C. for 48 hours in an environmental chamber maintained at 50% relative humidity. During this period, the resorcinol-formaldehyde polymerization reactions proceed to completion, forming a robust three-dimensional polymer network with average pore sizes of 12 nanometers. The controlled aging environment prevents moisture loss that could cause gel cracking or non-uniform density distribution.

After aging, the mold sections are carefully separated, revealing a self-supporting gel structure that maintains precise dimensional accuracy matching the original mold geometry. The demolded gel undergoes solvent exchange using sequential ethanol baths to replace the aqueous pore liquid, followed by supercritical drying with carbon dioxide at 42° C. and 90 bar pressure for 8 hours.

The resulting polymer aerogel insulator exhibits a density of 0.004 grams per cubic centimeter and thermal conductivity of 0.016 watts per meter-kelvin. The molded aerogel demonstrates superior dimensional control compared to direct dispensing methods, with thickness variations of less than 0.05 millimeters across the sensor surface and consistent wall thicknesses of 1.2 millimeters surrounding the thermoelectric cooler housing.

This molded approach provides several technical advantages over direct dispensing methods. The precision mold geometry ensures reproducible aerogel dimensions across multiple detector units, eliminating the variability inherent in free-form dispensing processes. The controlled fill rate and degassing procedures prevent void formation and density gradients that can compromise thermal insulation performance. The two-part mold design enables complete encapsulation of complex detector geometries while maintaining access for quality inspection during intermediate processing steps. Additionally, the molded aerogel exhibits enhanced mechanical stability due to the uniform stress distribution achieved during the controlled gelation process, reducing the likelihood of cracking or delamination during thermal cycling in operational environments.

The molded aerogel insulator achieves X-ray transmission equivalent to 6-micron beryllium across the 0.5 to 10 keV energy range while providing thermal insulation performance that maintains the sensor temperature within 0.2° C. of the target setpoint under ambient temperature variations of 20° C. The precision molding process enables the creation of integrated features such as desiccant cavities and wire routing channels that would be difficult to achieve with direct dispensing methods, further enhancing the overall detector performance and reliability.

The foregoing detailed description includes illustrative examples of various aspects and implementations and provides an overview or framework for understanding the nature and character of the claimed aspects and implementations. The drawings provide illustration and a further understanding of the various aspects and implementations and are incorporated in and constitute a part of this specification. The constituent elements of the disclosed device and system listed herein are intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device. Terms such as ‘approximate,’ ‘approximately,’ ‘about,’ etc., as used herein indicate a deviation of within +/−10%. Relationships between the various elements of the disclosed device as described herein are presented as illustrative examples only, and not intended to limit the scope or nature of the relationships between the various elements. Persons of ordinary skill in the art may appreciate that numerous design configurations may be possible to enjoy the functional benefits of the inventive systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

While operations are depicted in the drawings in a particular order, such operations are not required to be performed in the particular order shown or in sequential order, and all illustrated operations are not required to be performed. Actions described herein can be performed in a different order. The separation of various system components does not require separation in all implementations, and the described program components can be included in a single hardware or software product.

The phraseology and terminology used herein is for the purpose of description and should not be regarded as limiting. Any references to implementations or elements or acts of the systems and methods herein referred to in the singular may also embrace implementations including a plurality of these elements, and any references in plural to any implementation or element or act herein may also embrace implementations including only a single element. Any implementation disclosed herein may be combined with any other implementation or embodiment.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, unless otherwise noted, the use of the words “approximate,” “about,” “around,” “substantially,” etc., mean plus or minus ten percent.

The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

What is claimed is:

1. An X-ray detector comprising:
an endcap;
a sensor to detect X-rays, the sensor located within the endcap;
a thermoelectric cooler (TEC) located within the endcap to cool the sensor; and
an aerogel insulator within the endcap encapsulating at least the TEC to insulate the TEC.

2. The X-ray detector of claim 1, wherein the aerogel insulator encapsulates the sensor.

3. The X-ray detector of claim 1, wherein the aerogel insulator comprises at least one of a silica-based aerogel, a carbon-based aerogel, a metal oxide-based aerogel, or a polymer-based aerogel.

4. The X-ray detector of claim 1, wherein the aerogel insulator has an X-ray transmission comparable to or better than an X-ray transmission of an eight-micron thick beryllium window.

5. The X-ray detector of claim 1, wherein the aerogel insulator has a thermal conductivity between 0.01 W/m·K and 0.03 W/m·K and is capable of withstanding operational temperatures of the X-ray detector.

6. The X-ray detector of claim 1, wherein the aerogel insulator is coupled to the X-ray detector via an adhesive or other mechanical securing means.

7. The X-ray detector of claim 1, wherein the aerogel insulator is formed by dispensing gel solution within the endcap of the X-ray detector and drying the gel solution to form the aerogel within the endcap of the X-ray detector and in contact with the TEC of the X-ray detector.

8. A method comprising:
dispensing a gel solution within an endcap of an X-ray detector or a mold such that the gel solution contacts a thermoelectric cooler (TEC) of the X-ray detector;
drying the gel solution to form an aerogel insulator encapsulating the TEC of the X-ray detector; and
providing an insulating window above a sensor of the X-ray detector.

9. The method of claim 8, wherein the gel solution contacts the TEC and a sensor of the X-ray detector, and wherein the aerogel insulator encapsulates the TEC and the sensor of the X-ray detector.

10. The method of claim 8, wherein the insulating window includes an aerogel.

11. The method of claim 8, wherein drying the gel solution includes:
aging the gel solution to form a gel; and
supercritically drying the gel to form the aerogel insulator.

12. The method of claim 8, wherein the aerogel insulator comprises at least one of a silica-based aerogel, a carbon-based aerogel, a metal oxide-based aerogel, or a polymer-based aerogel.

13. The method of claim 8, wherein the aerogel insulator has an X-ray transmission comparable to or better than an X-ray transmission of an eight-micron thick beryllium window.

14. The method of claim 8, wherein the aerogel insulator has a thermal conductivity between 0.01 W/m·K and 0.03 W/m·K and is capable of withstanding operational temperatures of the X-ray detector.

15. The method of claim 8, wherein dispensing the gel solution within the endcap of the X-ray detector or the mold comprises dispensing the gel solution within the mold, the method further comprising:
aging the gel solution within the mold to form a gel;
removing the mold; and
drying the gel to form the aerogel insulator.

16. An aerogel insulator configured to be located within an endcap of an X-ray detector, wherein the aerogel insulator is configured to contact a thermoelectric cooler (TEC) of the X-ray detector to insulate the TEC of the X-ray detector.

17. The aerogel insulator of claim 16, wherein the aerogel insulator is configured to contact a thermoelectric cooler (TEC) and a sensor of the X-ray detector to insulate the TEC and the sensor.

18. The aerogel insulator of claim 17, wherein the aerogel insulator encapsulates the TEC and sensor.

19. The aerogel insulator of claim 16, wherein the aerogel insulator is formed by dispensing gel solution within the endcap of the X-ray detector and drying the gel solution to form the aerogel within the endcap of the X-ray detector and in contact with one or more components of the X-ray detector.

20. The aerogel insulator of claim 16, wherein the aerogel insulator comprises at least one of a silica-based aerogel, a carbon-based aerogel, a metal oxide-based aerogel, or a polymer-based aerogel, the aerogel insulator has an X-ray transmission comparable to or better than an X-ray transmission of an eight-micron thick beryllium window, and the aerogel insulator has a thermal conductivity between 0.01 W/m·K and 0.03 W/m·K.
